(19) United States
(12) Patent Application Publication
(10) Pub. No.: US 2008/0291006 A1
(43) Pub. Date: Nov. 27, 2008

(54) Wireless Sensors

(75) Inventors: Kee Seng Kang, West Sussex (GB); Tak Kwan Chan, West Sussex (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Powtier Controls Ltd., Lancing, West Sussex, GB (GB)

(21) Appl. No.: 11/596,721

(22) PCT Filed: May 19, 2005
(86) PCT No.: PCT/GB05/01972

§ 371 Date: Aug. 17, 2007

(30) Foreign Application Priority Data
May 19, 2004 (GB) 0411156.3

(51) Int. Cl. G08B 1/08

(52) U.S. Cl. 340/539.1

(57) ABSTRACT

A wireless sensor module comprises: input means (2) for determining a target piece of information such as temperature. A transmitter (18) is arranged to transmit this information to a remote receiver (48) in discrete bursts. The module's power supply (4) comprises one or more photovoltaic cells (22) at least one capacitor (34) arranged to be charged by the photovoltaic cell(s) (22). The capacitor is further arranged such that it may power the transmitter (18).

This invention relates to wireless sensors—particularly, although not exclusively, those which are suitable for monitoring environmental parameters such as temperature, pressure, gas concentration and so forth.

There are many varied applications where it is useful or desirable to be able to deploy sensors of one sort or another for monitoring environment conditions at a particular locality but which may be monitored remotely—e.g. at a central monitoring station. This could be on a small scale—e.g. monitoring the doors and windows of a house for a burglar alarm system or on a larger scale e.g. monitoring the temperature distribution throughout an office block or the gas concentration in a factory.

In small scale installations, sensors can be hard wired to a central monitoring station. This is beneficial in one respect in that the sensors do not then require their own power supply. However, as the size of the installation increases, this becomes less and less feasible. It can also be difficult satisfactorily to incorporate a network of sensors into a building unless carried out at the building or major refurbishment stage.

Many types of wireless sensor transmitters are known. For example wireless temperature sensors are used in food storage systems. Sensors for detecting the opening of door and windows, the breaking of glass or movement of an infra-red source are used in intruder alarm systems. A variety of wireless sensors exist for detecting different gases such as oxygen, carbon monoxide, hydrogen sulphide etc. Known sensors suffer from a common disadvantage that they are usually battery operated and therefore have a limited operating life.

The present invention aims to improve upon known sensor arrangements and provides a wireless sensor module comprising: input means for receiving a signal from a transducer determining a target piece of information; transmission means arranged to transmit said information to a remote receiver in discrete bursts; and a power supply comprising one or more photovoltaic cells and at least one capacitor arranged to be charged by said photovoltaic cell(s) and further arranged such that it may power said transmission means.

Thus it will be seen by those skilled in the art that in accordance with the invention a wireless sensor module includes a self-contained power supply that need not rely on a battery but rather derives power from incident light which is converted into electrical energy by the photovoltaic cell and stored in the capacitor. The Applicant has realised that although the amount of energy that may be stored in a capacitor is typically significantly less than may be stored in a battery of a similar size, the storage efficiency is much higher. Thus by arranging for the power requirements of the device to be able to be met by the capacity of the capacitor, such an arrangement can be made to be self sufficient over a long period of time. This is consistent with another advantage of a capacitor over a rechargeable battery that it has a much longer operating life in general. Capacitors are also less expensive than rechargeable batteries.

By arranging to transmit the information of interest only in discrete bursts, the power requirement is kept to a minimum. Of course the sustainable equilibrium power requirement of the sensor will depend upon the average amount of light available and its reliability. It will also be a function of the frequency with which transmissions are required.

The capacitor is preferably a so-called PC memory type capacitor which is characterised by a low leakage current compared to standard capacitors such as aluminium capacitors. In some preferred embodiments, it has been found that just a single capacitor will suffice. In one particular example, PC memory type aluminium electrolytic, capacitance 0.22 Farad, voltage rating 5V DC could be used, although higher values e.g. 1 Farad are also envisaged.

In other embodiments, however, the apparatus may include more than one capacitor. For example, in one set of embodiments, in addition to a PC memory type capacitor, a standard capacitor is also provided. The standard capacitor can provide the additional benefit of delivering a higher power for a shorter period of time—e.g. during a transmission. Although the standard capacitor will generally tend to maintain its charge for a shorter period of time than the memory type of capacitor, it may be useful in smoothing fluctuations in light level—e.g. during the daytime when the weather is characterised by sunny spells rather than a more continuous level of light. Preferably where capacitors having different characteristics are provided, they are arranged such that charge does not leak between them. For example one or more diodes could be provided.

The input means is preferably configured to accept signals from transducers giving millivolt or milliamp signals as these do not drain any electrical energy.

In accordance with the invention, the sensor transmits information in discrete bursts which helps to minimise the overall average power requirement. By “burst” it is intended to mean that the period of transmission is shorter than the period between transmissions, preferably much shorter. To give a particular example a transmission burst of 10 milliseconds might be made every 100 seconds—i.e. the transmissions would last on average only for one ten-thousandth of the time.

The sensor could be arranged to transmit information on a periodic basis but in at least some preferred embodiments, a transmission is only made if a predetermined criterion is met. For example, if the parameter being monitored is temperature, it may be decided to transmit temperature information only if it changes by more than 1° C. Alternatively, in an embodiment where the status of an object is being monitored such as whether a door is open or closed, it may be decided to transmit information only if the status changes. It will be appreciated that, depending upon the variability of the parameter being monitored, such an arrangement can significantly reduce the overall average power requirement of the sensor. In these embodiments where a decision is made as to whether to transmit information, it is preferred that if no transmission is made for a predetermined length of time, a “house keeping” transmission will be made in order to indicate to the monitoring station that the sensor is still operating correctly.

Even though in accordance with the invention transmissions are only made in discrete bursts and may, as described above, only be made infrequently when the information changes, the actual determination of the parameter, e.g. the measurement of temperature or determination of whether a door is open or closed, will me made more frequently or could even be made continuously.

Preferably determinations of the parameter are made only periodically. This allows a further conservation of power. Preferably the period of determination is shorter than the period between determinations. In between these periods of activity, the apparatus need only consume very low levels of power—e.g. just sufficient to operate a timer to determine when the sensor should make its next measurement or determination. Thus in accordance with such embodiments, the apparatus may be considered to have a sleep mode with extremely low power requirements and periodically to change to a wake-up mode in which the parameter in question is measured or determined. As previously described, the measurement or determination may or may not then be transmitted by the transmitter.

Although many ways of achieving sleep and wake-up modes are possible, preferably the apparatus comprises a microprocessor configured to operate with sleep and wake-up modes. Two specific examples of such microprocessors, based on proprietary standards, are AT86RF211 single chip transceiver and rfPIC12F675 transmitter, from Atmel and Microchip respectively. Preferably however the sensor is configured to operate in accordance with the ZigBee standard defined by the IEEE 802.15.4 standard. This is a global standard for wireless control and monitoring applications. Two wireless device types are mentioned in the IEE802.15.4, the Full Function Device (FFD) and Reduced Function Device (RFD). Most suitably the sensor is in accordance with the RFD part of the standard. This results in a device operating with the minimum implementation of EEE802.15.4 communication protocol. Such device can be put into sleep-mode, wake-up or transmit as and when required. Three specific examples of suitable radio frequency (RF) transceivers are Chipcon CC2420, Motorola MC1319x and Atmel AT86RF210.

In one particular example, the sleep mode has a power requirement of just 10 microwatts, the wake up mode has a power requirement of the order of 1 milliwatts and the transmission mode has a power requirement of the order of 50 milliwatts. However, by arranging for the period of the transmission mode and the wake up mode to be relatively short in comparison to the sleep mode, the average power requirement of such a device may be only of the order of a few microwatts.

Although in accordance with the invention it is not necessary to use a battery, it may in some circumstances be desirable to provide one as a further backup in case of poor light conditions. It will be appreciated, however, by using the invention the life of the battery may be significantly extended as compared to without the invention. In one particular example a single coin size 180 milliamp-hour battery is calculated to be able to last for a period of the order of 5 years.

Preferably the module comprises means for measuring the charge on the capacitor or capacitors and most preferably is arranged to transmit data relating to the charge to the remote receiver. This allows intelligent power management in the module itself and/or remotely and can, for example give warning of premature expiry of a particular module in a network.

Preferably the transmitter is arranged to transmit in one of the Low Power Radio Frequency bands which range from 34.5 Megahertz to 2400 Megahertz, e.g. 433 MHz.

A preferred embodiment of the present invention will now be described, by way of example only, with reference to the accompanying drawings in which:

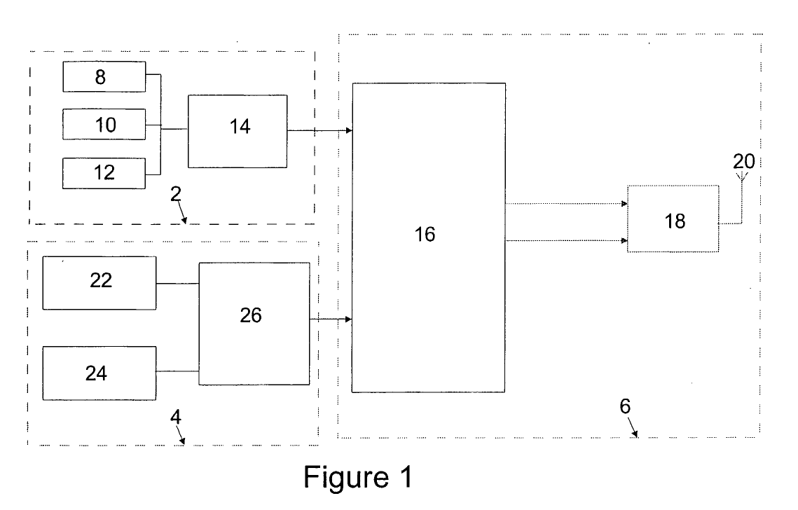

FIG. 1 is a block diagram showing the overall arrangement of an embodiment of the invention;

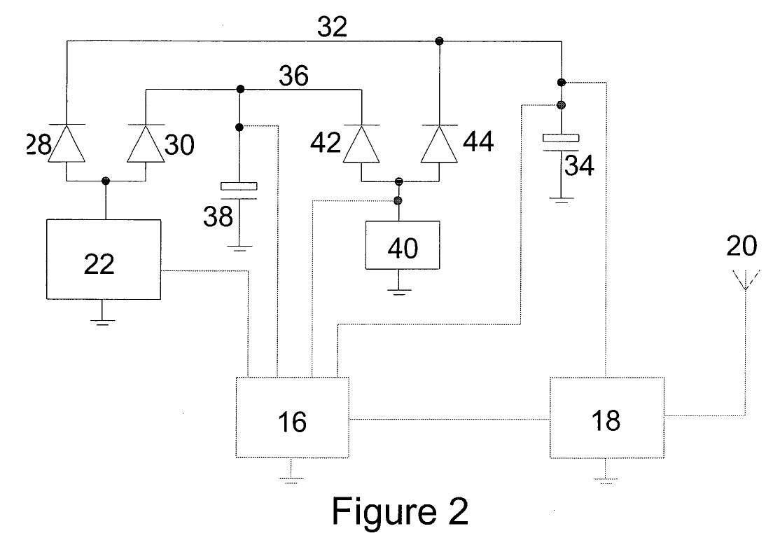

FIG. 2 is a schematic circuit diagram showing the power supply arrangement in the embodiment of FIG. 1; and

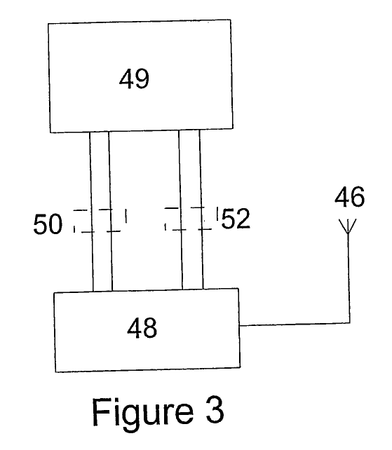

FIG. 3 is a schematic diagram showing a receiver for use with the embodiment of FIGS. 1 and 2.

Considering firstly FIG. 1, the three main modules of a wireless sensor in accordance with the embodiment of the invention are shown. These modules are a universal sensor input module 2, a power supply module 4, and a radio frequency (RF) micro-controller and transmitter module 6. The universal sensor input module is in general able to measure current, voltage or logical state by means of appropriate sub-modules 8, 10, 12 respectively. The input signals are amplified by an amplifier 14, the output of which is fed into the RF micro-controller module 6. This generic arrangement allows inputs from a wide variety of switches or measurement transducers to be accepted.

The RF micro-controller module 6 comprises a microprocessor 16 connected to a radio frequency transmitter 18 with associated antennae 20. These may be provided by a single chip transceiver such as the ZigBee CC2430 2.4 GHz RF transceiver available from Chipcon AS which has a power down current of just 1 micro-amp, although other similar transceivers from other manufacturers are suitable such as the Atmel AT128L. The microprocessor 16 includes a memory, a submodule operating the communication protocol and a submodule which controls the sleep and wake-up regime which will be explained later.

The power supply module 4 comprises a photovoltaic mini panel 22. One example of a suitable panel would be a part no. 1073402, from RWE Schott Solar which is an amorphous-silicon single cell on float glass. The panel has an area of 22×37 mm with a glass thickness of 2 mm. It also comprises battery and capacitors 24 and a power management sub-module 26. This sub-module comprises a low power current consumption microprocessor. Its purpose is to monitor the energy levels of the photovoltaic mini panel 22, capacitors and battery 24. Data relating to the energy levels of these components may be passed to the RF microcontroller 6 for transmission to a receiver along with the measured parameter.

Although the power management processor 26 and the RF microprocessor 16 are shown as separate elements in the schematic diagram of FIG. 1, they can be in practice be combined into a single microprocessor.

The power supply module will be described in greater detail with reference to FIG. 2.

Turning to FIG. 2, the photovoltaic mini-panel 22 may be seen at the left hand side of the circuit diagram. Connected to the output of the photovoltaic panel 22 are two diodes 28,30 respectively. The other side of the first of the two diodes 28 is connected to a common positive voltage rail 32. The positive voltage rail 32 connects directly to the RF transmitter 18 and a 470 μF (microfarad) 10V DC standard aluminium capacitor 34 in parallel with the transmitter.

The second of the diodes 30 connected to the photovoltaic panel 22 connects it to a second positive voltage rail 36 to which the microprocessor 16 and a second capacitor 38, which is a 0.22 F 5V DC PC memory type capacitor 38, are connected in parallel with one another. The microprocessor 16 is also connected to the transmitter 18 in order to control its operation and to pass data for transmission from its memory.

A standard 180 milliamp-hour, coin size battery 40 is connected to each of the two positive voltage rails 32,36 by means of a further two diodes 42,44 respectively. Each of the diodes 28,30,42,44 is chosen so as to give rise to a low voltage drop across it.

Operation of the embodiment of FIGS. 1 and 2 will now be described. The microcontroller module 6 is configured so as to have three possible modes. The first of these is the normal operating mode also known as “wake-up” mode in which the microprocessor 16 operates normally, processing and storing input from the sensing module 2 and the power management sub-module 26 but not in general causing the transmitter 18 to operate to transmit the data. The power consumption in this mode is of the order of 1 milliwatt. This power requirement can be met by the photovoltaic panel 22 as long as it is exposed at least to dim light of the order of 50 lux.

Considering FIG. 2, in this situation current will therefore flow from the photovoltaic panel 22 to the microcontroller 16 by means of the diode 30. If the photovoltaic panel 22 is receiving more light than this and thus generating a greater current, the memory type capacitor 38 will be charged. Similarly, if the photovoltaic panel 22 is generating insufficient current, the microprocessor will nonetheless be powered by discharging the capacitor 38. Thus even under very low light conditions, the sensor may still operate in the previously described wake-up mode. Furthermore, even if the memory capacitor 38 is fully discharged, power may be supplied by the battery 40 via the diode 42. However, the overall average power requirement of the microprocessor 16 is sufficiently low that it is only rarely necessary to draw any significant current from the battery 40. This will be explained in greater detail below with respect to the sleep mode of the sensor.

During wake-up mode the power management microprocessor 26 monitors the status of the solar panel energy 22, the PC memory type capacitor 38, the battery 40 and the standard capacitor 34. These statuses are then passed to the RF microcontroller for transmission along with the measurement data. This allows the state of the sensor apparatus itself to be monitored as well as the actual parameter being measured.

When it is required to transmit data from the sensor, the microprocessor 16 activates the transmitter 18 and passes it the data to be transmitted from its memory. The power consumption of the device is approximately 50 milliwatts which corresponds to a maximum of 10 milliwatts of RF transmission power. Although this power requirement is relatively high in this context, it is only required for short, infrequent bursts. For example, the microprocessor 16 could be configured to operate the transmitter only in bursts of 10 milliseconds every 100 seconds which would mean the average power requirement for the transmitter would be only 5 microwatts. Further savings in overall power are made by making a transmission only if the data has changed from the previous transmission e.g. if the temperature measured has changed by more than 1° C. or if the voltage at the battery has become critically low.

If the photovoltaic panel 22 is experiencing a high level of incident light when a transmission is required, it may power the transmitter 18 directly. For example, under sunlight with an instant light level of the order of 1000 lux, the panel 22 generates sufficient current to operate the transmitter. However, any shortfall in the power requirement may be met by the standard aluminium capacitor 34, or, failing that, the battery 40. In the example given above where transmission takes place only for one 10,000th of the cycle period, there is ample time for the capacitor 34 to be recharged during the gaps between transmissions in all but the very lowest light conditions.

Finally, a further saving in overall average power is made by employing a third, sleep mode during which all operation of the sensor is halted apart from a timer function which reawakens the rest of the sensor after a predetermined time. The power consumption during this sleep mode may be of the order of only 15 microwatts. This allows almost all of the electrical energy generated by the photovoltaic panel 22 to recharge the capacitors 34,38 or conversely in very low light conditions discharges the PC memory type capacitor 38 only to a very small degree. The low leakage current of memory type capacitors is exploited to allow smoothing of the power supply from the photovoltaic panel 22 over a relatively long period such as a day. On the other hand, the relatively high instant power capability of a standard aluminium capacitor 34 by virtue of his relatively low internal losses allows the high peak, low average power requirements of the transmitter 18 to be met even if insufficient instantaneous current is being generated by the photovoltaic panel 22.

FIG. 3 shows in simplified schematic form a suitable receiver for use with the wireless sensor of FIGS. 1 and 2. It broadly comprises a radio antenna 46 and associated RF receiver circuitry 48. This is connected into the USB (Universal Serial Bus) port 49 of a personal computer by means of a standard USB connector (not shown). This provides both a data connection 50 and a standard 5v power supply 52 so that the receiver does not require its own power supply. In order to commission the wireless sensor, the receiver shown in FIG. 3 is switched in to commissioning mode and an appropriate button (not shown) is pressed on the wireless sensor so that it transmits its identity to the receiver. If the sensor identity is accepted by the network, it will be shown on the personal computer.

In a particular example, the transmitter 18 is one which operates at 433 megahertz and 10 milliwatts which gave a transmission range of 100 metres in open air and 50 metres indoors. Any frequency in the non-licensed Low Power Radio Frequency bands could be used.

By considering the embodiments described above, the following advantages which may be achieved are apparent. Firstly apparatus in accordance with the preferred embodiments can have a long operating life—for example 10 to 20 years is achievable. Even in circumstances where a battery is needed (e.g. low ambient light, or high current drain sensor), a life of 5 to 10 years should be achievable. This compares favourably to the life of known devices.

Secondly the use of capacitors allows rapid charging. Sensor units in accordance with preferred embodiments could be charged from an artificial light source such as an infra-red lamp or placed under a window sill during to be exposed to regular daylight. To give one example a prototype unit made in accordance with the description give above was placed about 60 centimetres under a 100 watt filament lamb bulb and was found to be fully charged within 15 minutes.

It will also be appreciated that preferred embodiments allow intelligent power management as they are able to transmit the status of the energy stored, e.g. in the capacitor(s) and/or battery and warn of possible early failure.

A wide range of sensor types is accommodated in accordance with preferred embodiments of the invention—in essence any sensor capable of generating electrical signals is suitable, for example, thermocouple and oxygen sensors generate milli-volt signals; carbon monoxide sensors generate micro-ampere signals.

The described embodiment can operate successfully under low light conditions (50 lux) either indoors or outdoors.
Finally, with the RF receiver connected to a PC USB port as shown in FIG. 3, a PC running Windows (registered trade mark) operating system provides most of the hardware and software building blocks for connecting to the Internet. With available World Wide Web technology, a user can use a web browser to view the system anywhere in the world.

It should be appreciated that the embodiment described above is just one example of the application of the principles of the invention and may be modified in various respects within the scope of the invention. For example, it is not essential to have two capacitors and in some applications one—e.g. the memory type capacitor may be sufficient. Similarly, the battery is not essential.

1. A wireless sensor module comprising: input means for receiving a signal from a transducer determining a target piece of information; transmission means arranged to transmit said information to a remote receiver in discrete bursts; and a power supply comprising one or more photovoltaic cells and at least one capacitor arranged to be charged by said photovoltaic cell(s) and further arranged such that it may power said transmission means.

2. A sensor module as claimed in claim 1 wherein said capacitor is a memory type capacitor.

3. A sensor module as claimed in claim 2 further comprising a standard capacitor.

4. A sensor module as claimed in claim 3 arranged to prevent leakage between said memory type capacitor and said standard capacitor.

5. A sensor module as claimed in claim 1 comprising means for measuring the charge on said capacitor or capacitors.

6. A sensor module as claimed in claim 5 arranged to transmit data relating to said charge to said remote receiver.

7. A sensor module as claimed in claim 1 arranged to transmit said information only if a predetermined criterion is met.

8. A sensor module as claimed in claim 7 wherein said information is transmitted if it has changed since a previous transmission or has changed by more than a predetermined amount.

9. A sensor module as claimed in claim 7 further arrange to make a transmission if no transmission has otherwise been made for a predetermined length of time.

10. A sensor module as claimed in claim 1 arranged to determine said information periodically.

11. A sensor module as claimed in claim 10 wherein the period of determination is shorter than the period between determinations.

12. A sensor module as claimed in claim 1 further comprising a back-up battery.

13. A sensor module as claimed in claim 1 wherein said transmission means is arranged to transmit at a frequency in the range 34.5 Megahertz to 2400 Megahertz.

14. A sensor module as claimed in claim 1 adapted to operate in accordance with the ZigBee standard.
